(19) United States
(12) Patent Application Publication
(10) Pub. No.: US 2011/0267371 A1
(43) Pub. Date: Nov. 3, 2011

(54) SYSTEM AND METHOD FOR CONTROLLING TOUCHPAD OF ELECTRONIC DEVICE

(75) Inventors: YONG-JUN SONG, Shenzhen City (CN); XING-LONG TENG, Shenzhen City (CN); CHENG-DONG YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/854,911

(22) Filed: Aug. 12, 2010

(30) Foreign Application Priority Data
Apr. 28, 2010 (CN) 201010158353.6

(51) Int. Cl. G06F 3/041; G09G 5/00

(52) U.S. Cl. 345/660; 345/672

(57) ABSTRACT

A system and method for controlling a touchpad of an electronic device detects if a lingering touch is detected on a first region of the touchpad. If the lingering touch is detected on the first region, functions of a second region and a third region of the touchpad are disabled. If a subsequent contact is also detected on the first region, an object displayed on the display activates zoom function. If the lingering touch is detected on the second region, functions of the third region are disabled. If the lingering touch is detected on the second region and a subsequent sliding touch is detected on the first region, the object is may be dragged according to the sliding touch on the touchpad.

### BACKGROUND

1. Technical Field

Embodiments of the present disclosure relates to controlling management systems and methods, and more particularly, to a system and method for controlling a touchpad of an electronic device.

2. Description of Related Art

An electronic device such as a laptop computer, may not have cursor operation buttons (such as a left cursor button and a right cursor button), but use a touchpad to provide functions of the cursor buttons. For example, the touchpad may provide two operation regions, one works as the left cursor button and the other works as the right cursor button. However, if there a touch of a finger lingers on a region of the touchpad longer than a preset amount of time, a function of another region of the electronic device may be mistakenly activated.

### BRIEF DESCRIPTION OF THE DRAWINGS

FIG. 1 is a block diagram of one embodiment of an electronic device 1 comprising a control system.

FIG. 2 is a block diagram of one embodiment of function modules of the control system in FIG. 1.

FIG. 3a and FIG. 3b are a flowchart of one embodiment of a method for controlling a touchpad.

FIG. 4 is a schematic diagram illustrating the touchpad.

### DETAILED DESCRIPTION

The disclosure is illustrated by way of examples and not by way of limitation in the fingers of the accompanying drawings in which like references indicate similar elements. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may be comprised of connected logic units, such as gates and flip-flops, and may comprise programmable units, such as programmable gate arrays or processors. The modules described herein may be implemented as either software and/or hardware modules and may be stored in any type of computer-readable medium or other computer storage device.

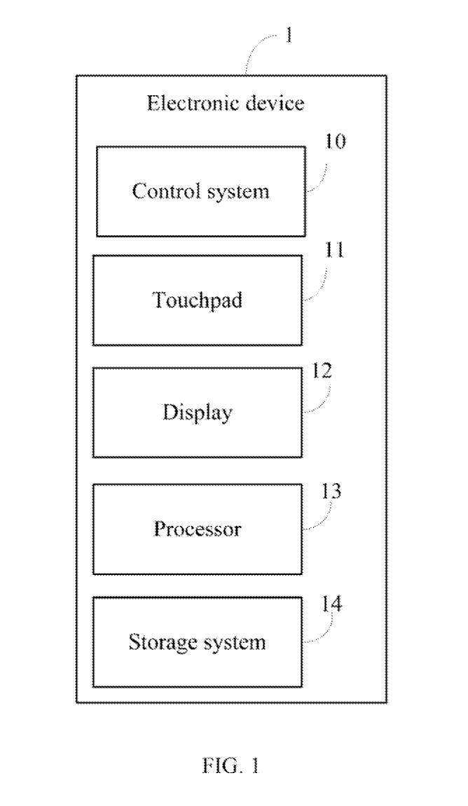

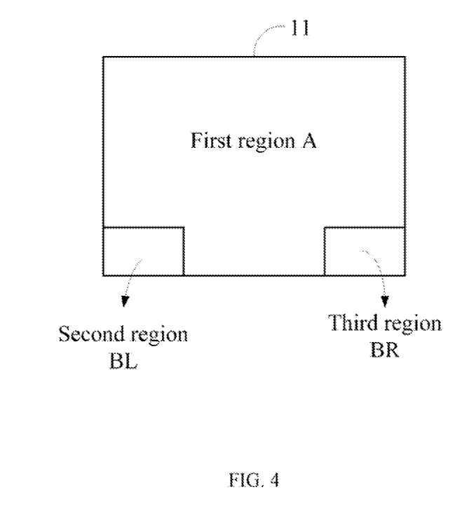

FIG. 1 is a block diagram of one embodiment of an electronic device 1. The electronic device 1 includes a control system 10, a touchpad 11, a display 12, a processor 13, and a storage system 14. In one embodiment, the electronic device 1 may be a laptop computer, although the disclosure is not limited thereto. The control system 10 may be used to control operations of the electronic device 1 in response to contact operations on the touchpad 11. In one embodiment, the touchpad 11 includes three regions, a first region marked by a character “A”, a second region marked by characters “BL”, and a third region marked by characters “BR”. As shown in FIG. 4, the first region is available for a user to select items displayed on the display 12. The second region is available for the user to control cursor movement on the display 12. The third region is available for control of function menus of items displayed on the display 12. For example, one or more computerized codes of the control system 10 are stored in the storage system 14, where the processor 13 executes computerized codes, to provide one or more aforementioned cursor or control operations of the control system 10.

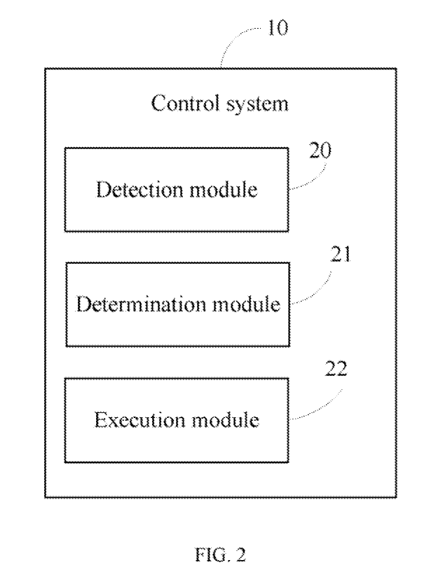

As shown in FIG. 2, the control system 10 may include a detection module 20, a determination module 21, and an execution module 22.

The detection module 20 detects if there is a lingering touch (e.g., a first finger) on the touchpad 11. It should be understood that the “lingering touch” is a state of when a finger of a user touches and remains on the touchpad 11. The detection module 20 detects the first lingering touch on the touchpad 11 when capacitance of a point on the touchpad 11 changes for a predefined time.

The determination module 21 determines if the lingering touch is detected on the first region. The execution module 22 disables functions of the second region and the third region if the lingering touch is detected on the first region. In one embodiment, it is understood that, if the lingering touch is detected on the first region. The second region and the third region, provides the same function as the first region. For example, the second region and the third region may be available for the user to select items displayed on the display 12.

If the lingering touch is detected on the first region, the determination module 21 further determines if a contact (e.g., a second finger) is also detected on the first region by the detection module 20. In one embodiment, the contact may be a tapping touch, a sliding touch, or a lingering touch. If the contact is also detected on the first region, the execution module 22 zooms in or out on an object displayed on the display 12. In one embodiment, the object displayed on the display 12 may be a picture, a dialog box, or font sizes of characters of a textbox. When the user places the second finger on the touchpad 11, without removing the first finger, and moves the first finger and the second finger apart, the execution module 22 zooms in on the object displayed on the display 12. Likewise, when the user places the first finger and the second finger on the touchpad 11 and moves the first finger and the second finger together, the execution module 12 zooms out from the object displayed on the display 12. If no contact is detected on the first region, and the first finger is not lifted from the touchpad 11, the execution module 22 controls movement of the cursor displayed on the display 12 in accordance with the movements of the lingering touch on the touchpad 11 like regular mouse movements.

The determination module 21 determines if the lingering touch is detected on the second region if the lingering touch is not detected on the first region.

If the lingering touch is detected on the second region, the execution module 22 disables functions of the third region, and the determination module 21 further determines if a sliding touch is detected on the first region. In one embodiment, it should be understood that the “sliding touch” is a state of where a finger of a user is placed and move along the touchpad 11 with a smooth continuous motion. The execution module 22 drags the object displayed on the display 12 according to movement of the sliding touch on the touchpad 11 if the sliding touch is detected on the first region. The execution module 22 executes the functions of the second region if no sliding touch is detected on the first region.

The execution module 22 disables functions of the first region and the second region if the lingering touch is detected on the third region. That is, the first region and the second region provides the same functions as the third region.

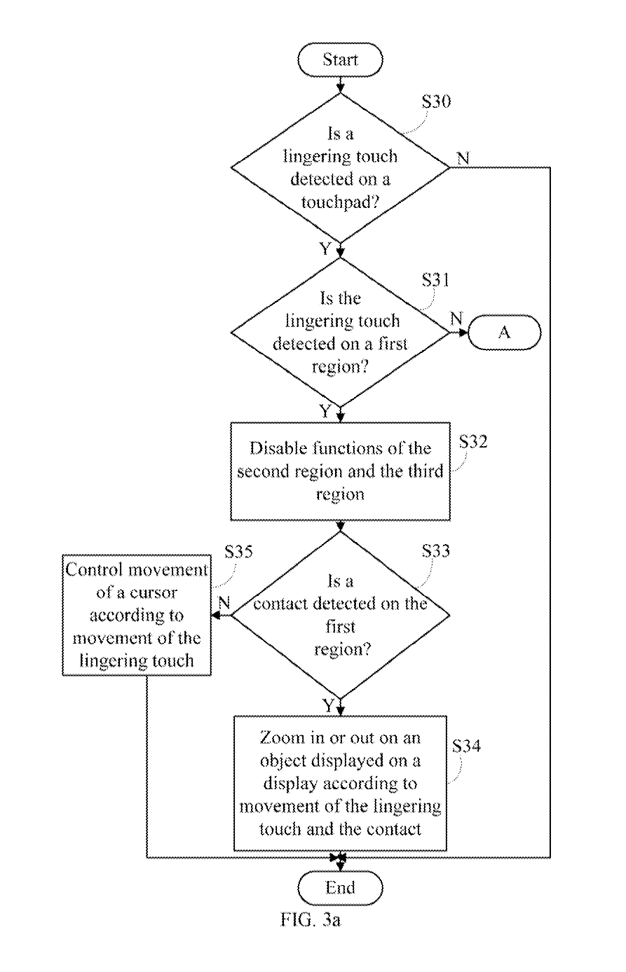

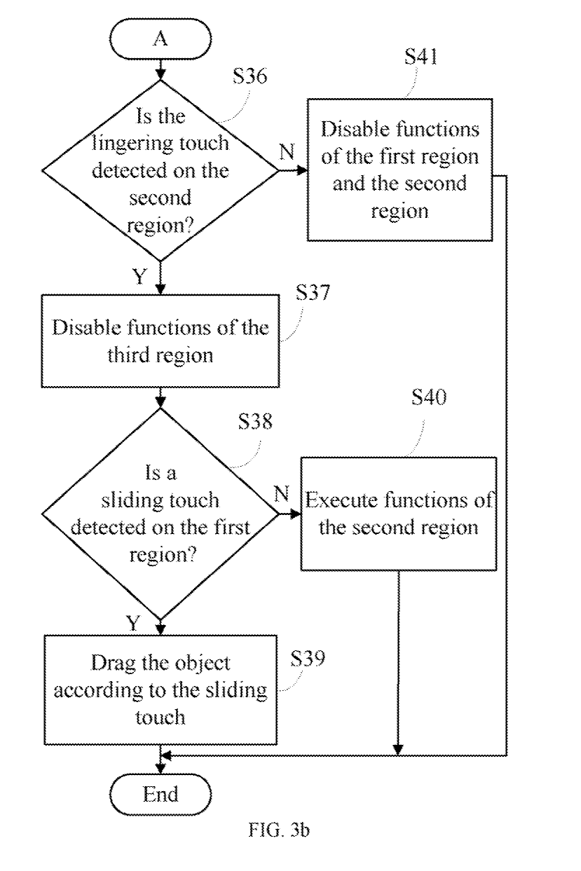

FIG. 3a and FIG. 3b are a flowchart of one embodiment of a method for controlling the touchpad 11. Depending on the embodiment, additional blocks may be added, others removed, and the ordering of the blocks may be rearranged.

In block S30, the detection module 20 detects if there is a lingering touch (e.g., a first finger) on the touchpad 11. If no lingering touch is detected on the touchpad 11, the procedure ends. If the lingering touch is detected on the touchpad 11, block S31 is implemented.

In block S31, the determination module 21 determines if the lingering touch is detected on the first region. If the lingering touch is detected on the first region, block S32 is implemented. If the lingering touch is not detected on the first region, block S36 is implemented.

In block S32, the execution module 22 disables functions of the second region and the third region. That is, the second region and the third region provides the same functions as the first region.

In block S33, the determination module 21 determines if a contact (e.g., a second finger) is also detected on the first region. In one embodiment, the contact may be a tapping touch, a sliding touch, or a lingering touch. If no contact is detected on the first region, in block S35, the execution module 22 controls movement of a cursor displayed on the display 12 according to movement of the lingering touch on the touchpad 11 like regular mouse movements. Then, the procedure ends. If the contact is detected on the first region, block S34 is implemented.

In block S34, the execution module 22 zooms in or out on an object displayed on the display 12. Then, the procedure ends. In one embodiment, when the user places both fingers on the touchpad 11 and moves them apart, the execution module 22 zooms in on the object displayed on the display 12. Likewise, when the user places the first fingers and the second finger on the touchpad 11 and moves the first finger and the second finger together, the execution module 12 zooms out from the object displayed on the display 12.

In block S36, the determination module 21 determines if the contact is detected on the second region. If the contact is not detected on the first and second regions, the first contact is detected, by default, from the third region, then the procedure goes to block S41, the execution module 22 disables functions of the first region and the second region. That is, the first region and the second region provide the same functions as the third region. Then, the procedure ends. Otherwise, if the lingering touch is detected on the second region, block S37 is implemented.

In block S37, the execution module 22 disables functions of the third region. That is, the third region provides the same functions as the second region.

In block S38, the determination module 21 determines if a sliding touch is detected on the first region. If no sliding touch is detected on the first region, in block S40, the execution module 22 executes functions of the second region. Otherwise, if the sliding touch is detected on the first region, block S39 is implemented.

In block S39, the execution module 22 drags the object displayed on the display 12 according to the sliding touch on the touchpad 11. Then, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage system;
at least one processor; and
a control system being stored in the storage system and executable by the at least one processor, the control system comprising:
an execution module operable to disable functions of a second region and a third region of a touchpad of the electronic device if a lingering touch is detected on a first region of the touchpad;
a determination module operable to determine if a contact is detected on the first region of the touchpad;
the execution module also operable to zoom in or out on an object displayed on a display of the electronic device if the contact is detected on the first region, and control movement of a cursor displayed on the display according to movement of the lingering touch on the touchpad if the contact is not detected on the first region of the touchpad;
the execution module further operable to disable functions of the third region of the touchpad if the lingering touch is detected on the second region;
the determination module further operable to determine if the contact is detected on the first region if the lingering touch is detected on the second region;
the execution module further operable to drag the object displayed on the display according to movement of the contact on the touchpad if the contact is detected on the first region, and execute functions of the second region if the contact is not detected on the first region; and
the execution module further operable to disable functions of the first region and the second region if the lingering touch is detected on the third region of the touchpad.

2. The electronic device as claimed in claim 1, wherein the object displayed on the display of the electronic device is a picture, a dialog box, or font sizes of characters of a textbox.

3. The electronic device as claimed in claim 1, wherein the object is zoomed out on the display if the lingering touch and the contact move apart on the touchpad, and the object is zoomed in on the display if the lingering touch and the contact moves together on the touchpad.

4. A method for controlling a touchpad of an electronic device, comprising:
(a) determining if a lingering touch is detected on a first region of the touchpad, in response to the lingering touch is detected on the first region, block (b) is implemented, and in response to the lingering touch is not detected on the first region, block (c) is implemented;
(b) disabling functions of a second region and a third region of the touchpad, determining if a contact is detected on the first region of the touchpad, and zooming in or out on an object displayed on a display of the electronic device according to movement of the lingering touch and the contact if the contact is detected on the first region, or controlling movement of a cursor displayed on the display according to movement of the lingering on the touchpad if no contact is detected on the first region of the touchpad;
(c) determining if the lingering touch is detected on the second region, in response to the lingering touch is detected on the second region, block (d) is implemented, and in response to the lingering touch is not detected on the second region, block (e) is implemented;
(d) disabling functions of the third region of the touchpad, determining if a sliding touch is detected on the first region, dragging the object displayed on the display according to the sliding touch on the touchpad if the contact is detected on the first region, or executing functions of the second region if no contact is detected on the first region; and
(e) disabling functions of the first region and the second region.

5. The method as claimed in claim 4, wherein the object displayed on the display of the electronic device is a picture, a dialog box, or font sizes of characters of a textbox.

6. The method as claimed in claim 4, wherein the zooming step further comprising:
zooming out on the object displayed on the display if the lingering touch and the contact move apart on the touchpad; and
zooming in on the object on the display if the lingering touch and the contact moves together on the touchpad.

7. A non-transitory storage medium storing a set of instructions, the set of instructions capable of being executed by a processor to perform a method for controlling a touchpad of an electronic device, the method comprising:
(a) determining if a lingering touch is detected on a first region of the touchpad, in response to the lingering touch is detected on the first region, block (b) is implemented, and in response to the lingering touch is not detected on the first region, block (c) is implemented;
(b) disabling functions of a second region and a third region of the touchpad, determining if a contact is detected on the first region of the touchpad, and zooming in or out on an object displayed on a display of the electronic device according to movement of the lingering touch and the contact if the contact is detected on the first region, or controlling movement of a cursor displayed on the display according to movement of the lingering on the touchpad if no contact is detected on the first region of the touchpad;
(c) determining if the lingering touch is detected on the second region, in response to the lingering touch is detected on the second region, block (d) is implemented, and in response to the lingering touch is not detected on the second region, block (e) is implemented;
(d) disabling functions of the third region of the touchpad, determining if a sliding touch is detected on the first region, dragging the object displayed on the display according to the sliding touch on the touchpad if the contact is detected on the first region, or executing functions of the second region if no contact is detected on the first region; and
(e) disabling functions of the first region and the second region.

8. The non-transitory storage medium as claimed in claim 7, wherein the object displayed on the display of the electronic device is a picture, a dialog box or font sizes of characters of a textbox.

9. The non-transitory storage medium as claimed in claim 7, wherein the zooming step further comprising:
zooming out on the object displayed on the display if the lingering touch and the contact move apart on the touchpad; and
zooming in on the object on the display if the lingering touch and the contact moves together on the touchpad.
